(19) United States
(12) Patent Application Publication
(10) Pub. No.: US 2019/0090285 A1
(43) Pub. Date: Mar. 21, 2019

(54) LOCATION RESTRICTION FOR MOBILE COMPUTING DEVICE COMMUNICATION

(71) Applicant: Microsoft Technology Licensing, LLC, Redmond, WA (US)

(72) Inventors: Amer Aref HASSAN, Kirkland, WA (US); Russell Andrew PENAR, Highlands Ranch, CO (US)

(73) Assignee: Microsoft Technology Licensing, LLC, Redmond, WA (US)

(21) Appl. No.: 15/709,331

(22) Filed: Sep. 19, 2017

(51) Int. Cl. H04W 76/00; H04M 7/00; H04W 4/02; H04L 29/06; H04W 4/22

(52) U.S. Cl. CPC H04W 76/007; H04M 7/006; H04W 4/22; H04L 65/1069; H04W 4/021

(57) ABSTRACT

A method for mobile device communication includes, on a mobile computing device, receiving a request to establish a communication with a specified remote device. One or more unique hardware addresses of one or more network devices in a local environment of the mobile computing device are detected. The detected unique hardware addresses are compared to a set of previously-approved unique hardware addresses associated with a set of familiar network devices detectable from an approved communications location. Based on determining that the detected unique hardware addresses match the previously-approved unique hardware addresses by at least a similarity threshold, the mobile computing device is determined to be at the approved communications location, and the communication with the specified remote device is established.

### BACKGROUND

Mobile computing devices (e.g., cellular telephones, tablets, laptops) can be used to establish communications with specific remote devices, such as other mobile computing devices, landline phones, etc. Unlike stationary devices (e.g., landline phones), mobile computing devices can initiate communications regardless of the current location of the mobile computing device. This can present problems in certain situations, for example when the mobile computing device is used to contact an emergency response service, as such services typically expect or require that communications to originate from known and/or identifiable physical addresses.

### BRIEF DESCRIPTION OF THE DRAWINGS

FIG. 1 schematically depicts a communication between a mobile computing device and a specified remote device.

FIG. 2 schematically depicts another example communication between the mobile computing device and the specified remote device.

FIG. 3 illustrates an example method for mobile device communication.

FIG. 4 schematically depicts detection of unique hardware addresses of local network devices.

FIG. 5 schematically depicts comparison of detected unique hardware addresses to previously-approved unique hardware addresses.

FIG. 6 schematically depicts an example computing system.

### DETAILED DESCRIPTION

As indicated above, mobile computing devices, such as cellphones, smartphones, tablet computers, laptop computers, etc., are often used to communicate with specified remote devices. A variety of solutions allow such communication to take place over the Internet and other suitable public networks. In an example scenario, computer software installed on a mobile computing device may receive, digitize, and transmit a user's spoken words to a user-specified remote computing device over the Internet. The technology that enables this type of communication is often referred to as Voice over Internet Protocol (VoIP), as it enables digitized audio to be packetized and transmitted over suitable Internet Protocol networks. This is different from traditional landline or cellular telephone services that rely on the public switched telephone network.

However, VoIP and similar technologies can present challenges. One issued associated with VoIP calls arises when attempting to establish a communication that is location-sensitive. In one example scenario, a user may use a VoIP service to place a phone call to a Public-Safety Access Point (PSAP), such as an emergency response service. However, unlike landline phones that are associated with known physical addresses, as well as cellular telephone calls that can be physically located using cell towers, VoIP calls are often not associated with physical locations that emergency services can respond to. Some jurisdictions have attempted to address this problem by mandating that each VoIP line be associated with a known physical address (e.g. a user's home or office address). However, mobile devices are still capable of placing VoIP calls to emergency services even when not at the known physical address, raising the possibility that the emergency services could send help to the wrong location.

Accordingly, the present disclosure is directed to a technical solution that can address the problems outlined above, in which a mobile device is permitted to establish a communication with a specified remote device only after determining that the mobile computing device is at an approved communications location. Specifically, upon receiving a request to establish a communication with a specified remote device, the mobile computing device detects unique hardware addresses of nearby network devices (e.g., WIFI routers/hotspots). The mobile computing device then compares the detected unique hardware addresses to previously-approved hardware addresses of familiar network devices detectable from an approved communications location. If it is determined that the mobile computing device is at the approved communications location, then the communication is established. Implementing the solution described herein has the technical effect of allowing mobile computing devices to establish location-sensitive communications in approved locations, while blocking such communications in non-permitted locations. This can, for example, ensure that emergency services have accurate information regarding the locations from which emergency calls are placed, as well as additional benefits that will be described in more detail below.

It will be understood that the present disclosure is not limited to voice-based communication, or even audio-based communication. Rather, a “communication” as described herein may include the exchange of any suitable information between a mobile computing device and a specified remote device over a network. For example, in some situations, the communication may be an exchange of computer data between the mobile computing device and the specified remote device (e.g., as part of a file sharing application). In specific examples, the communication can include audio and/or video (e.g., as a VoIP call), though neither audio nor video need be included. Further, while the above example described a mobile computing device communicating with a PSAP, it will be understood that the techniques described herein are applicable to communications with any specified remote device.

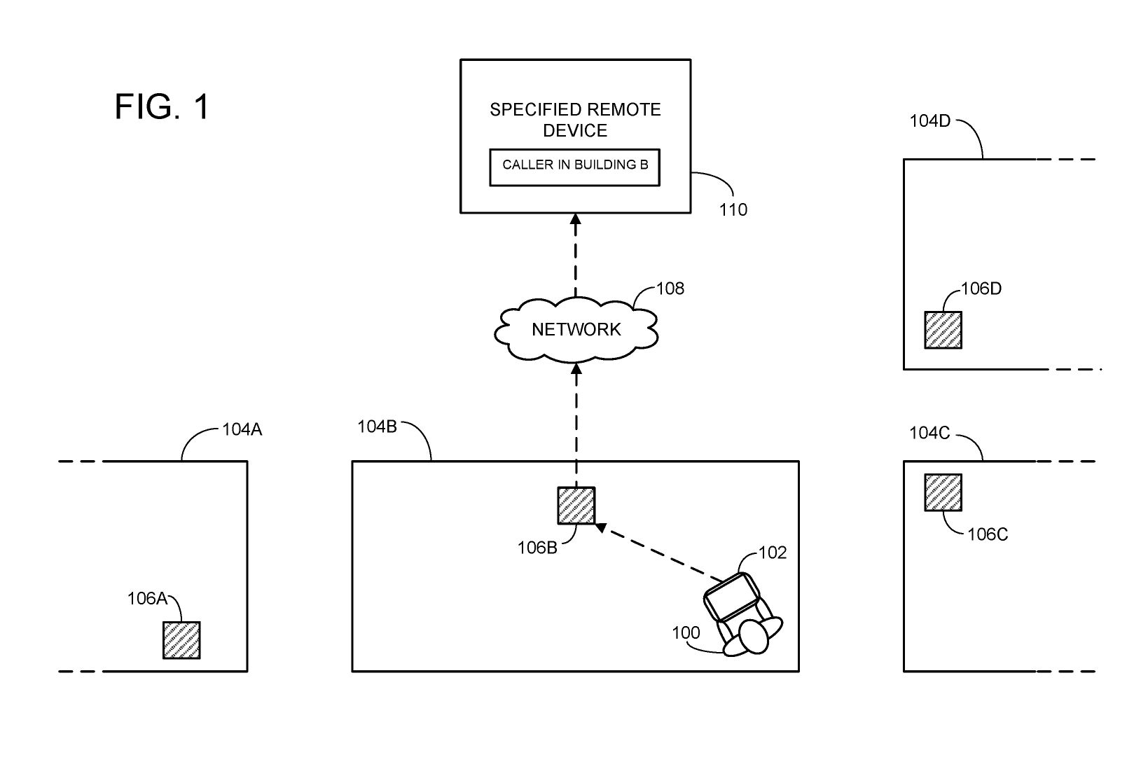

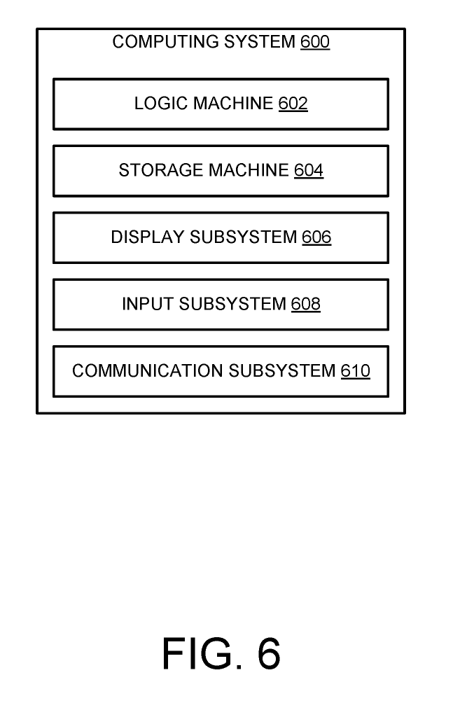

FIG. 1 schematically illustrates an example communication between a mobile computing device and a specified remote device. Specifically, FIG. 1 shows a user 100 using a mobile computing device 102. As indicated above, a mobile computing device may have any of a variety of suitable form factors. As examples, a mobile computing device may take the form of a mobile telephone, smartphone, tablet computer, laptop computer, and/or any other suitable computing device that is not permanently associated with a single physical location. In some examples, a mobile computing device may be implemented as computing system 600 described below with respect to FIG. 6.

Schematically depicted in FIG. 1 are four different buildings 104A-104D, and user 100 is within building 104D. FIG. 1 also shows four different network devices 106A-106B, each network device being located in a different building. “Network device,” as used herein, can refer to any of a variety of suitable network hardware, including modems, wireless routers, switches, access points, and/or any other suitable network devices that feature a unique hardware address that can be detected by a mobile computing device.

As shown, mobile computing device 102 is communicating with network device 106B, which is facilitating exchange of information between the mobile computing device and a network 108. Specifically, mobile computing device 102 has connected to network 108 to establish a communication with a specified remote device 110. The specified remote device may be any suitable device capable of receiving a communication from a mobile computing device. For example, the specified remote device may be another mobile computing device (e.g., smartphone, laptop, tablet), a stationary computing device (e.g., a desktop or server computer), a dedicated communications device (e.g., a landline phone or VoIP phone), etc.

The communication between the mobile computing device and the specified remote device may begin once the mobile computing device receives a request to establish the communication, and this can be done in any number of ways. For example, the user of the mobile computing device may specify a remote device to be contacted by, for example, dialing a telephone number. In other cases, the communication may be established when the user specifies a unique network address (e.g., a Uniform Resource Locator or an email address), selects a specific device name, username, screenname, contact address, etc., launches a software application, etc. Further, in some cases, the communication may be established without human intervention. In other words, the communication may be established automatically by a software application, hardware device, etc.

In a specific example, specified remote device 110 may be associated with a PSAP, such as an emergency response service, and the communication between mobile computing device 102 and the specified remote device may be an emergency call. Such a communication may, for example, be a VoIP call to the PSAP placed after user 100 dials an emergency number, however other forms of communication are contemplated by this disclosure. As discussed above, some jurisdictions mandate each VoIP line, and/or similar communications channel, be associated with a known physical location that does not dynamically update when a mobile computing device used to establish communications is temporarily located away from the known physical location. For example, a VoIP line used by mobile computing device 102 may be associated with building 104B, for example in a database maintained by a PSAP, a VoIP service provider, a local regulator, etc. Accordingly, when the communication is established between the mobile computing device and the PSAP, the specified remote device may retrieve information indicating that the mobile computing device is associated with building 104B, as shown in FIG. 1. Accordingly, the PSAP may then dispatch help to building 104B.

Though the above example focuses on an emergency call, it will be understood that location-selectivity may be important in other types of communications. For example, a user working with sensitive information may only be authorized to use a specific mobile device and/or communicate with a specific remote device when the user is at an approved location. This can be done to ensure that, for example, the user does not transmit secure or confidential information to unauthorized parties or from potentially insecure locations. However, the problem outlined above remains, in that mobile computing devices are typically capable of initiating a communication from any of a variety of locations, and it is difficult to determine whether the mobile computing device is at an approved location or not when a request to establish a communication is received.

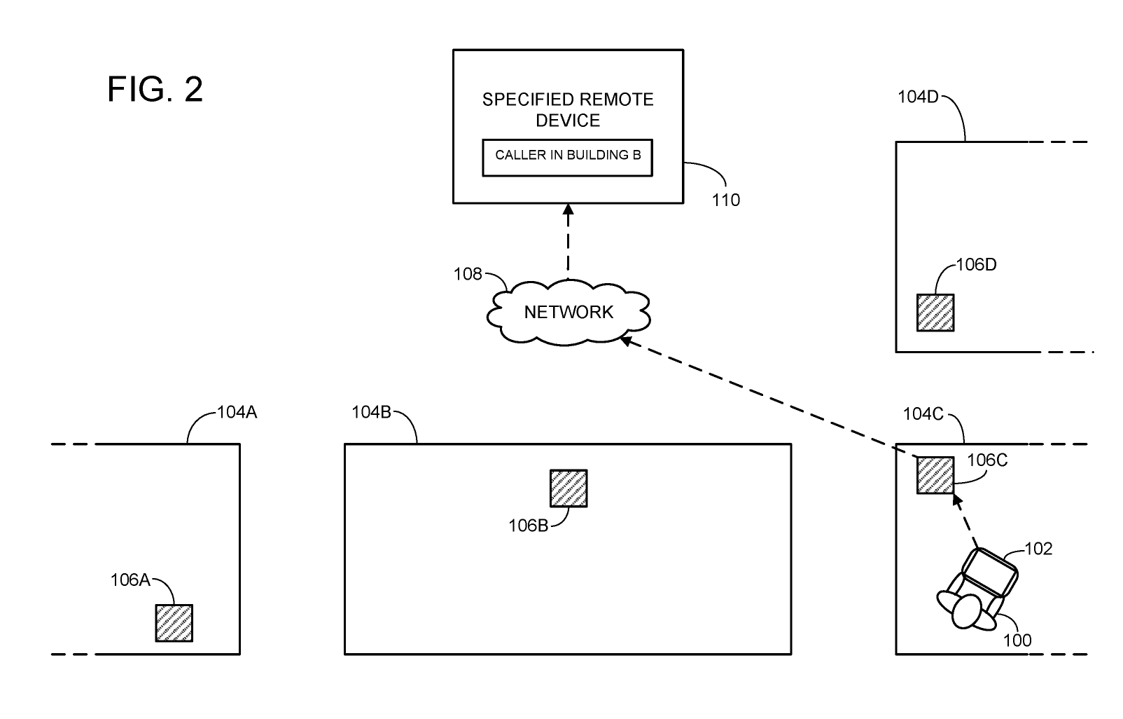

This problem is illustrated in FIG. 2, which again shows user 100 and mobile computing device 102. However, in the example of FIG. 2, user 100 is in building 104C as opposed to building 104B. Similar to the example above, user 100 may use mobile computing device 102 to contact a PSAP with a VoIP call. However, as discussed above, in some jurisdictions VoIP lines, and/or similar communications channels, may be associated with known physical locations that do not update as mobile devices move from place to place. Accordingly, if mobile device 102 is used to place an emergency call to a PSAP, the PSAP may erroneously conclude that the mobile device is in building 104B, as that is the physical location associated with the communications channel. The PSAP may then dispatch help to building 104B, despite the fact that the call was placed from building 104C. This problem can be exacerbated when the call is placed from even further away from the known physical location. In other examples, privileged individuals may be able to access secure or confidential information on, for example, government or corporate servers, despite being located in an insecure area.

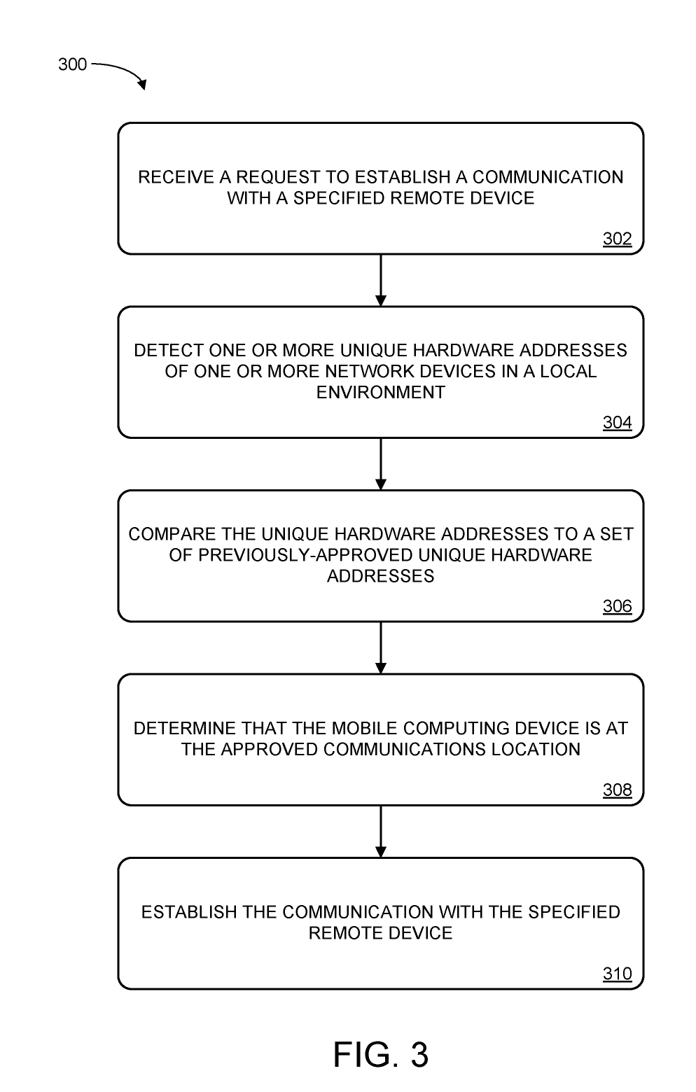

Accordingly, FIG. 3 illustrates an example method 300 for mobile device communication, in which a mobile computing device is permitted to communicate with a specified remote device only when the mobile computing device is at an approved communications location. Method 300 may be implemented on any suitable hardware including, for example, smartphones, laptops, tablet computers, desktops, servers, media centers, wearable computing devices, etc. In some examples, method 300 may be implemented on computing system 600 described below with respect to FIG. 6.

At 302, method 300 includes receiving a request to establish a communication with a specified remote device. As discussed above, this may occur in any of a variety of ways. For example, a user may dial a telephone number, specify a unique network address, select a unique device name, username, screenname, contact address, etc., launch a software application, and or request a communication in other suitable ways. In other examples, the request to establish the communication need not be provided by a human user, but rather may be automatically generated by a software application, hardware device, etc. Further, a specified remote device may take any suitable form, such as a dedicated communications device, mobile computing device, stationary computing device, etc.

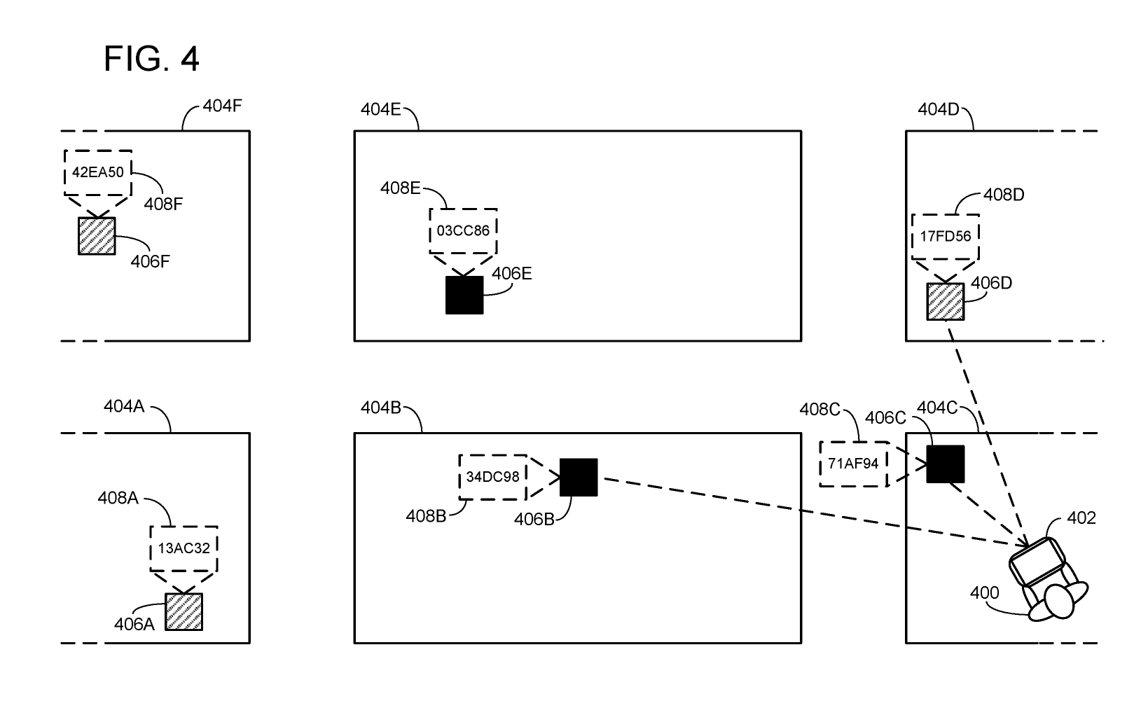

At 304, method 300 includes detecting one or more unique hardware addresses of one or more network devices in a local environment of the mobile communications device. This is schematically depicted in FIG. 4, which shows a user 400 using an example mobile communications device 402. FIG. 4 also shows several buildings 404A-404F, as well as several network devices 406A-406F. Each of the depicted network devices has a unique hardware address 408. In other words, network device 406A has a unique hardware address 408A, network device 406B has a unique hardware address 408B, etc. These unique hardware addresses may take any suitable form, and the specific unique hardware addresses shown in FIG. 4 are intended as examples only. In some cases, a unique hardware address may be a Media Access Control (MAC) address of an Internet-connected device.

In FIG. 4, mobile computing device 402 has detected the unique hardware addresses of network devices 406B, 406C, and 406D. These may be, for example, the network devices currently detectable from the current position of the mobile computing device, the network devices that the mobile computing device is permitted to access, the network devices running software compatible with the mobile computing device, etc. It will be understood that the network devices detected by the mobile computing device need not all have the same capabilities or hardware configurations, and in some cases the detected unique hardware addresses may have different attributes or formats.

Returning briefly to FIG. 3, at 306, method 300 includes comparing the unique hardware addresses to a set of previously-approved unique hardware addresses. In some cases, the set of previously approved unique hardware addresses may be associated with a set of familiar network devices detectable from an approved communications location. An “approved communications location” will typically refer to a single physical location that can be identified by a unique address. As examples, an approved communications location can refer to a specific building, room, office, dormitory, complex, outdoor venue, landmark, etc. Such an approved location may be defined in any suitable way, for example via a street address, longitude/latitude, GPS coordinates, etc. This is shown in FIG. 4, in which the approved communications location is building 404B, and the network devices detectable from building 404B include devices 406B, 406C, and 406E, shown as black squares.

The list of previously-approved unique hardware addresses may be established and maintained in any suitable way. In some cases, the previously-approved unique hardware devices may be defined through an enrollment process, in which any network devices detectable from an approved communications location are enrolled as the set of previously-approved unique hardware addresses. In other examples, the set of previously-approved unique hardware addresses may be manually defined and curated, for example by a user of the mobile computing device or an IT professional.

The list of previously-approved unique hardware addresses may be stored on or maintained by any suitable device, such as the mobile computing device, a server associated with a VoIP or other communications provider, a computer maintained by a communications regulator, a corporate/government device, etc. In a specific example, the set of previously-approved unique hardware addresses may be stored in a certificate on the mobile computing device. In some cases, this certificate may expire after a specified amount of time. This can ensure that the approved communications location for a particular mobile computing device is updated regularly, and can also provide a mechanism for temporary approvals—for example enabling renters or contract workers to establish communications from an approved location only during a specified period of time.

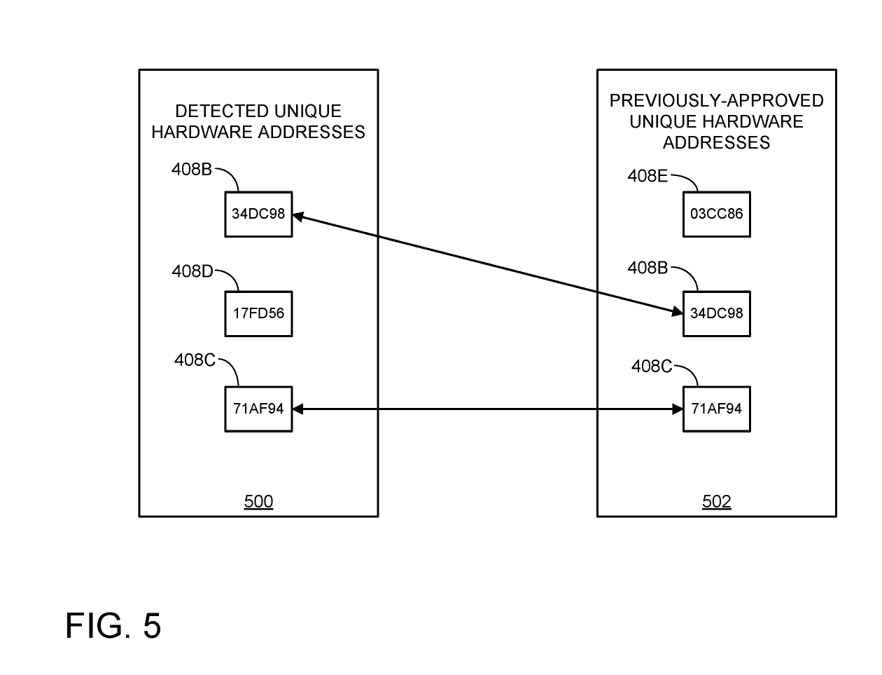

Comparing of a set of detected unique hardware addresses to a set of previously-approved unique hardware addresses is illustrated in FIG. 5. Specifically, FIG. 5 shows a set of unique hardware addresses 500 including the unique hardware addresses detected by mobile computing device 402 in FIG. 4. FIG. 5 also shows a set of previously-approved unique hardware addresses 502, including unique hardware addresses corresponding to the familiar network devices depicted in FIG. 4. As shown in FIG. 5, unique hardware addresses 408B and 408C are both detected by the mobile computing device and included in the set of previously-approved unique hardware addresses. Meanwhile, unique hardware address 408D is detected by the mobile computing device though not previously approved, and unique hardware address 408E is included in the set of previously-approved unique hardware addresses though not currently detected by the mobile computing device.

Returning briefly to FIG. 3, at 308, method 300 includes determining that the mobile computing device is at the approved communications location. This may be done upon determining that the set of detected unique hardware addresses matches the set of previously-approved unique hardware addresses by at least a similarity threshold. Depending on the implementation and desired degree of security/specificity, the similarity threshold may be defined in any suitable way.

In one scenario, the similarity threshold may be simply specify that at least one of the detected unique hardware addresses is a previously-approved unique hardware address. In other words, the detected unique hardware addresses match the previously-approved unique hardware addresses by at least the similarity threshold when at least one of the detected unique hardware addresses is a previously-approved unique hardware address. This may ensure that the mobile computing device cannot establish a communication with the specified remote device unless the mobile computing device is at least within the vicinity of the approved communications location. According to this condition, mobile device 402 in FIG. 4 would be determined to be at the approved communications location, as two of the detected unique hardware addresses are previously-approved unique hardware addresses.

In situations where more security or specificity is desired, the similarity threshold may be defined in other suitable ways. In an example scenario, the detected unique hardware addresses may be determined to match the previously-approved unique hardware addresses by at least the similarity threshold when all of the previously-approved unique hardware addresses are among the detected unique hardware addresses. Meeting this condition may provide relatively high certainty that the mobile computing device is at the approved communications location. If this similarity threshold were used in the example of FIG. 4, mobile computing device 402 would not be determined to be at the approved communications location, as unique hardware address 408E is not currently detectable by the mobile computing device.

In situations where fraud or hacking are concerns, other similarity thresholds may be used. For example, in some situations, the detected unique hardware addresses may be determined to match the previously-approved unique hardware addresses by at least the similarity threshold when all of the detected unique hardware addresses are previously-approved unique hardware addresses. In other words, if even a single unique hardware address is detected that is not previously approved, then the mobile computing device is determined not to be at the approved communications location. This may be especially useful in government or corporate settings, when presence of unrecognized network devices could represent a compromise of network security. If this similarity threshold were used in the example of FIG. 4, then the mobile computing device would be determined not to be at the approved communications location, as the mobile computing device has detected unique hardware address 408D, which does not correspond to a familiar network device.

Returning briefly to FIG. 3, at 310, method 300 includes, upon determining that the mobile computing device is at the approved communications location, establishing the communication with the specified remote device. This may be done in any of a variety of ways, as discussed above. For example, this can include placing a phone call to a user-specified phone number (e.g., to a PSAP, via VoIP), interacting with a specified corporate or government server, exchanging a file with a privileged peer, etc.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 6 schematically shows a non-limiting embodiment of a computing system 600 that can enact one or more of the methods and processes described above. Computing system 600 is shown in simplified form. Computing system 600 may take the form of one or more personal computers, server computers, tablet computers, home-entertainment computers, network computing devices, gaming devices, mobile computing devices, mobile communication devices (e.g., smart phone), and/or other computing devices.

Computing system 600 includes a logic machine 602 and a storage machine 604. Computing system 600 may optionally include a display subsystem 606, input subsystem 608, communication subsystem 610, and/or other components not shown in FIG. 6.

Logic machine 602 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 604 includes one or more physical devices configured to hold instructions executable by the logic machine to implement the methods and processes described herein. When such methods and processes are implemented, the state of storage machine 604 may be transformed—e.g., to hold different data.

Storage machine 604 may include removable and/or built-in devices. Storage machine 604 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 604 may include volatile, nonvolatile, dynamic, static, read/write, read-only, random-access, sequential-access, location-addressable, file-addressable, and/or content-addressable devices.

It will be appreciated that storage machine 604 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 602 and storage machine 604 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 implemented to perform a particular function. In some cases, a module, program, or engine may be instantiated via logic machine 602 executing instructions held by storage machine 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 606 may be used to present a visual representation of data held by storage machine 604. This visual representation may take the form of a graphical user interface (GUI). As the herein described methods and processes change the data held by the storage machine, and thus transform the state of the storage machine, the state of display subsystem 606 may likewise be transformed to visually represent changes in the underlying data. Display subsystem 606 may include one or more display devices utilizing virtually any type of technology. Such display devices may be combined with logic machine 602 and/or storage machine 604 in a shared enclosure, or such display devices may be peripheral display devices.

When included, input subsystem 608 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 610 may be configured to communicatively couple computing system 600 with one or more other computing devices. Communication subsystem 610 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 600 to send and/or receive messages to and/or from other devices via a network such as the Internet.

In an example, a method for mobile device communication comprises: on a mobile computing device, receiving a request to establish a communication with a specified remote device; detecting one or more unique hardware addresses of one or more network devices in a local environment of the mobile computing device; comparing the unique hardware addresses of the one or more network devices to a set of previously-approved unique hardware addresses associated with a set of familiar network devices detectable from an approved communications location; based on determining that the detected unique hardware addresses match the previously-approved unique hardware addresses by at least a similarity threshold, determining that the mobile computing device is at the approved communications location; and establishing the communication with the specified remote device. In this example or any other example, the detected unique hardware addresses match the previously-approved unique hardware addresses by at least the similarity threshold when at least one of the detected unique hardware addresses is a previously-approved unique hardware address. In this example or any other example, the detected unique hardware addresses match the previously-approved unique hardware addresses by at least the similarity threshold when all of the previously-approved unique hardware addresses are among the detected unique hardware addresses. In this example or any other example, the detected unique hardware addresses match the previously-approved unique hardware addresses by at least the similarity threshold when all of the detected unique hardware addresses are previously-approved unique hardware addresses. In this example or any other example, the communication is a Voice over Internet Protocol (VoIP) call. In this example or any other example, the VoIP call is to a Public-Safety Answering Point (PSAP). In this example or any other example, the communication is an exchange of computer data between the mobile computing device and the remote communications device. In this example or any other example, the method further comprises, prior to receiving the request to establish the communication with the specified remote device, enrolling a set of unique hardware addresses associated with network devices detectable from the approved communications location as the set of previously-approved unique hardware addresses. In this example or any other example, the set of previously-approved unique hardware addresses is stored in a communications approval certificate that expires after a specified amount of time.

In an example, a mobile computing device comprises: a communications subsystem; a logic machine; and a storage machine holding instructions executable by the logic machine to: receive a request to establish a communication with a specified remote device; detect one or more unique hardware addresses of one or more network devices in a local environment of the mobile computing device; compare the unique hardware addresses of the one or more network devices to a set of previously-approved unique hardware addresses associated with a set of familiar network devices detectable from an approved communications location; based on determining that the detected unique hardware addresses match the previously-approved unique hardware addresses by at least a similarity threshold, determine that the mobile computing device is at the approved communications location; and via the communications subsystem, establish the communication with the specified remote device. In this example or any other example, the detected unique hardware addresses match the previously-approved unique hardware addresses by at least the similarity threshold when at least one of the detected unique hardware addresses is a previously-approved unique hardware address. In this example or any other example, the detected unique hardware addresses match the previously-approved unique hardware addresses by at least the similarity threshold when all of the previously-approved unique hardware addresses are among the detected unique hardware addresses. In this example or any other example, the communication is a Voice over Internet Protocol (VoIP) call. In this example or any other example, the VoIP call is to a Public-Safety Answering Point (PSAP). In this example or any other example, the communication is an exchange of computer data between the mobile computing device and the remote communications device.

In an example, a mobile computing device comprises: means for receiving a request to establish a communication with a specified remote device; means for detecting one or more unique hardware addresses of one or more network devices in a local environment of the mobile computing device; means for comparing the unique hardware addresses of the one or more network devices to a set of previously-approved unique hardware addresses associated with a set of familiar network devices detectable from an approved communications location; means for determining that the mobile computing device is at the approved communications location upon determining that the detected unique hardware addresses match the previously-approved unique hardware addresses by at least a similarity threshold; and means for establishing the communication with the specified remote device. In this example or any other example, the detected unique hardware addresses match the previously-approved unique hardware addresses by at least the similarity threshold when at least one of the detected unique hardware addresses is a previously-approved unique hardware address. In this example or any other example, the detected unique hardware addresses match the previously-approved unique hardware addresses by at least the similarity threshold when all of the previously-approved unique hardware addresses are among the detected unique hardware addresses. In this example or any other example, the communication is a Voice over Internet Protocol (VoIP) call to a Public-Safety Answering Point (PSAP). In this example or any other example, the communication is an exchange of computer data between the mobile computing device and the remote communications device.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for mobile device communication, comprising:
on a mobile computing device, receiving a request to establish a communication with a specified remote device;
detecting two or more unique hardware addresses of two or more network devices in a local environment of the mobile computing device;
comparing the unique hardware addresses of the two or more network devices to a set of previously-approved unique hardware addresses associated with a set of familiar network devices detectable from an approved communications location;
based on determining that the detected unique hardware addresses match the previously-approved unique hardware addresses by at least a similarity threshold, determining that the mobile computing device is at the approved communications location; and
establishing the communication with the specified remote device.

2. The method of claim 1, where the detected unique hardware addresses match the previously-approved unique hardware addresses by at least the similarity threshold when at least one of the detected unique hardware addresses is a previously-approved unique hardware address.

3. The method of claim 1, where the detected unique hardware addresses match the previously-approved unique hardware addresses by at least the similarity threshold when all of the previously-approved unique hardware addresses are among the detected unique hardware addresses.

4. The method of claim 1, where the detected unique hardware addresses match the previously-approved unique hardware addresses by at least the similarity threshold when all of the detected unique hardware addresses are previously-approved unique hardware addresses.

5. The method of claim 1, where the communication is a Voice over Internet Protocol (VoIP) call.

6. The method of claim 5, where the VoIP call is to a Public-Safety Answering Point (PSAP).

7. The method of claim 1, where the communication is an exchange of computer data between the mobile computing device and the remote communications device.

8. The method of claim 1, further comprising, prior to receiving the request to establish the communication with the specified remote device, enrolling a set of unique hardware addresses associated with network devices detectable from the approved communications location as the set of previously-approved unique hardware addresses.

9. The method of claim 8, where the set of previously-approved unique hardware addresses is stored in a communications approval certificate that expires after a specified amount of time.

10. A mobile computing device, comprising:
a communications subsystem;
a logic machine; and
a storage machine holding instructions executable by the logic machine to:
receive a request to establish a communication with a specified remote device;
detect two or more unique hardware addresses of two or more network devices in a local environment of the mobile computing device;
compare the unique hardware addresses of the two or more network devices to a set of previously-approved unique hardware addresses associated with a set of familiar network devices detectable from an approved communications location;
based on determining that the detected unique hardware addresses match the previously-approved unique hardware addresses by at least a similarity threshold, determine that the mobile computing device is at the approved communications location; and
via the communications subsystem, establish the communication with the specified remote device.

11. The mobile computing device of claim 10, where the detected unique hardware addresses match the previously-approved unique hardware addresses by at least the similarity threshold when at least one of the detected unique hardware addresses is a previously-approved unique hardware address.

12. The mobile computing device of claim 10, where the detected unique hardware addresses match the previously-approved unique hardware addresses by at least the similarity threshold when all of the previously-approved unique hardware addresses are among the detected unique hardware addresses.

13. The mobile computing device of claim 10, where the communication is a Voice over Internet Protocol (VoIP) call.

14. The mobile computing device of claim 10, where the VoIP call is to a Public-Safety Answering Point (PSAP).

15. The mobile computing device of claim 10, where the communication is an exchange of computer data between the mobile computing device and the remote communications device.

16. A mobile computing device, comprising:
means for receiving a request to establish a communication with a specified remote device;
means for detecting two or more unique hardware addresses of two or more network devices in a local environment of the mobile computing device;
means for comparing the unique hardware addresses of the two or more network devices to a set of previously-approved unique hardware addresses associated with a set of familiar network devices detectable from an approved communications location;
means for determining that the mobile computing device is at the approved communications location upon determining that the detected unique hardware addresses match the previously-approved unique hardware addresses by at least a similarity threshold; and
means for establishing the communication with the specified remote device.

17. The mobile computing device of claim 16, where the detected unique hardware addresses match the previously-approved unique hardware addresses by at least the similarity threshold when at least one of the detected unique hardware addresses is a previously-approved unique hardware address.

18. The mobile computing device of claim 16, where the detected unique hardware addresses match the previously-approved unique hardware addresses by at least the similarity threshold when all of the previously-approved unique hardware addresses are among the detected unique hardware addresses.

19. The mobile computing device of claim 16, where the communication is a Voice over Internet Protocol (VoIP) call to a Public-Safety Answering Point (PSAP).

20. The mobile computing device of claim 16, where the communication is an exchange of computer data between the mobile computing device and the remote communications device.
